(19) United States
(12) Patent Application Publication
(10) Pub. No.: US 2014/0055990 A1
(43) Pub. Date: Feb. 27, 2014

(54) SOLID STATE HOSPITALITY LAMP

(71) Applicant: Express Imaging Systems, LLC, Seattle, WA (US)

(72) Inventor: William G. Reed, Seattle, WA (US)

(73) Assignee: Express Imaging Systems, LLC, Seattle, WA (US)

(21) Appl. No.: 13/973,696

(22) Filed: Aug. 22, 2013

Related U.S. Application Data
(60) Provisional application No. 61/692,619, filed on Aug. 23, 2012.

(51) Int. Cl. F21V 15/00

(52) U.S. Cl. CPC F21V 15/005
USPC 362/218; 362/217.14; 362/217.02; 362/249.01; 362/235

(57) ABSTRACT

A luminaire includes one or more solid state light modules, each having one or more theft deterrent features. Each of the one or more solid state light modules can include a number of solid state light sources. The one or more solid state light modules can be physically and electrically coupled to the luminaire such that any attempt to remove the solid state light module renders the solid state light module or the solid state light sources permanently inoperable. One or more theft deterrent features may be incorporated into the luminaire to deter theft. In one instance an external power converter supplying the solid state light module can be physically secured to a power source using one or more security mechanisms.

### BACKGROUND

1. Technical Field

The present disclosure generally relates to the field of illumination devices and, more particularly, to solid state illumination devices.

2. Description of the Related Art

The hospitality industry includes lodging facilities ranging from small, privately owned Bed & Breakfast inns to mammoth, corporate-owned, 2,500-plus room resort hotels. In the United States, it is estimated that annual hospitality energy costs may average as much as $2 per square foot or almost $500 per year for an average hotel room. The 24/7 nature of most commercial hospitality operations makes the hospitality industry one of the top five most intensive energy users in the United States commercial sector.

Whether on vacation or business travel, energy conservation is typically not at the forefront of a guest's mind. Leaving the room with lights on and the thermostat set to a comfortable temperature is often viewed as a “perk” by guests who feel that a room rate covers such energy wasting behaviors. Lighting can represent a significant portion of the overall costs within the hospitality industry. Incandescent light bulbs convert about 5% of the energy used into visible light, with the vast majority of the energy consumed wasted as heat. Compact fluorescent lights (CFLs) can convert about 30% of the energy consumed by the light source into visible light. Solid state light sources such as light emitting diodes (e.g., LEDs) can convert about 70% of the energy consumed by the light source into visible light and have up to 50 times greater life than incandescent bulbs having a comparable light output and up to 5 times greater life than fluorescent bulbs having a comparable light output.

The benefits of using LED lighting in the hospitality industry are readily apparent. However, with a typical 60 Watt incandescent light costing about $1.25, a typical 60 Watt equivalent CFL costing about $3.95, and a typical 60 Watt equivalent LED light costing about $39.95, the use of LED lights in uncontrolled settings such as guest rooms in the hospitality industry makes the lights an attractive, and lucrative, theft target. From an industry perspective, while the energy and cost savings possible using LED lights is quite attractive, any return recognized by their use is more than offset by their high replacement cost in the event of damage or theft.

New approaches to providing LED light sources and LED light fixtures suitable for use in the hospitality industry while incorporating one or more theft deterring features are therefore needed.

### BRIEF SUMMARY

Converting even a portion of the existing incandescent and compact fluorescent lighting fixtures in use within the hospitality industry to more energy efficient solid state light fixtures can permit an hotelier to recognize a significant reduction in energy costs associated with guest room and common area lighting. The attractiveness of such energy savings and the relatively high cost of such solid state light fixtures are not lost on the guests staying in the hotel. Providing solid state hospitality light fixtures having one or more theft deterrent features can assist hospitality providers in meeting energy cost reduction and environmental or “green” goals. However, such will require features that reduce the likelihood of theft of such lighting fixtures or solid state light sources (i.e., solid state “light bulbs”). Various such features are described herein.

A solid state light fixture may be summarized as including a stand that has a base and at least one elongated support member physically coupled to the base; a light module that includes a number of solid state light sources, the light module physically permanently attached to the at least one support member such that an attempted removal of the light module renders at least one of the light module or the solid state light sources permanently inoperable; and an external power supply pluggable to an alternating current electrical power outlet, the external power supply electrically conductively coupled to the light module that includes the solid state light sources to provide direct current electrical power thereto via at least one cable with at least two wires, the external power supply non-removably physically coupled to at least a portion of the stand via the at least one cable.

The external power supply may include at least one security mechanism that in use securely attaches the external power supply to alternating current electrical power outlet. The external power supply may include at least two prongs receivable by respective ones of at least two slots of the alternating current electrical power outlet, and the security mechanism may include a ring having an opening sized to receive a threaded security fastener therethrough, the ring positioned relative to the prongs to align a center of the opening with a center tap hole of the alternating current electrical power outlet when the prongs are received by the respective slots of the alternating current electrical power outlet.

The solid state light fixture may further include a diffuser attached to the stand, for example permanently attached to the stand.

The solid state light fixture may further include a dimmer control to manually adjust the luminous output of the number of solid state light sources. The dimmer control may include a manual dimmer.

The solid state light fixture may further include a motion sensor communicably coupled to the lamp control subsystem, the motion sensor to provide a motion signal to the microcontroller when movement is detected in an area about the solid state light fixture.

A solid state light module may be summarized as including a number of solid state light sources physically coupled to a structure; at least one physical coupler to operably connect the structure to a support member, the at least one physical coupler including one or more features that when physically coupled to the support member, render at least one of the solid state light module or the solid state light sources permanently inoperable upon attempted removal of the structure from the support member; and at least one electrical coupler to conductively connect the solid state light module to a power source via at least one cable with at least two wires, the electrical coupler including one or more features that, once engaged to the power source, render at least one of the solid state light module or the solid state light sources permanently inoperable upon attempted removal of the structure from the support member.

The solid state light module may further include at least one power controller conductively coupled to the number of solid state light sources and conductively coupled to the electrical coupler to adjust the luminous output of at least a portion of the number of solid state light sources.

The solid state light module may further include a manual dimmer switch operably coupled to the at least one power controller.

The solid state light module may further include a microcontroller conductively coupled to the power controller, the microcontroller having at least one input and at least one output, the at least one output communicably coupled to the at least one power controller.

The solid state light module may further include at least one intensity controller communicably coupled to the at least one microcontroller input.

The solid state light module may further include at least one of a motion detector or a proximity detector communicably coupled to the at least one microcontroller input.

The solid state light module may further include a diffuser physically coupled to the solid state light module.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a block diagram showing a solid state light fixture including a solid state light module and a remote power supply, according to one non-limiting illustrated embodiment.

FIG. 2 is a perspective view showing a solid state light fixture suitable for use in the hospitality industry, according to one non-limiting illustrated embodiment.

FIG. 3 is a perspective view showing a solid state light module for use in a solid state light fixture, according to one non-limiting illustrated embodiment.

FIG. 4 is a perspective view showing a solid state table lamp fixture suitable for use in the hospitality industry, according to one non-limiting illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known or well-documented structures associated with lighting fixtures, microcontrollers, nontransitory storage media, optical sensors, and the like have not been shown or described in detail to avoid unnecessarily obscuring descriptions of the embodiments.

Unless the context requires otherwise, throughout the specification and claims which follow, the word “comprise” and variations thereof, such as “comprises” and “comprising,” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Additionally, the terms “lighting” and “illumination” are used herein interchangeably. For instance, the phrases “level of illumination” or “level of light output” have the same meanings. Also, for instance, the phrases “illumination source” and “light source” have the same meanings.

The headings and Abstract of the Disclosure provided herein are for convenience only and do not interpret the scope or meaning of the embodiments.

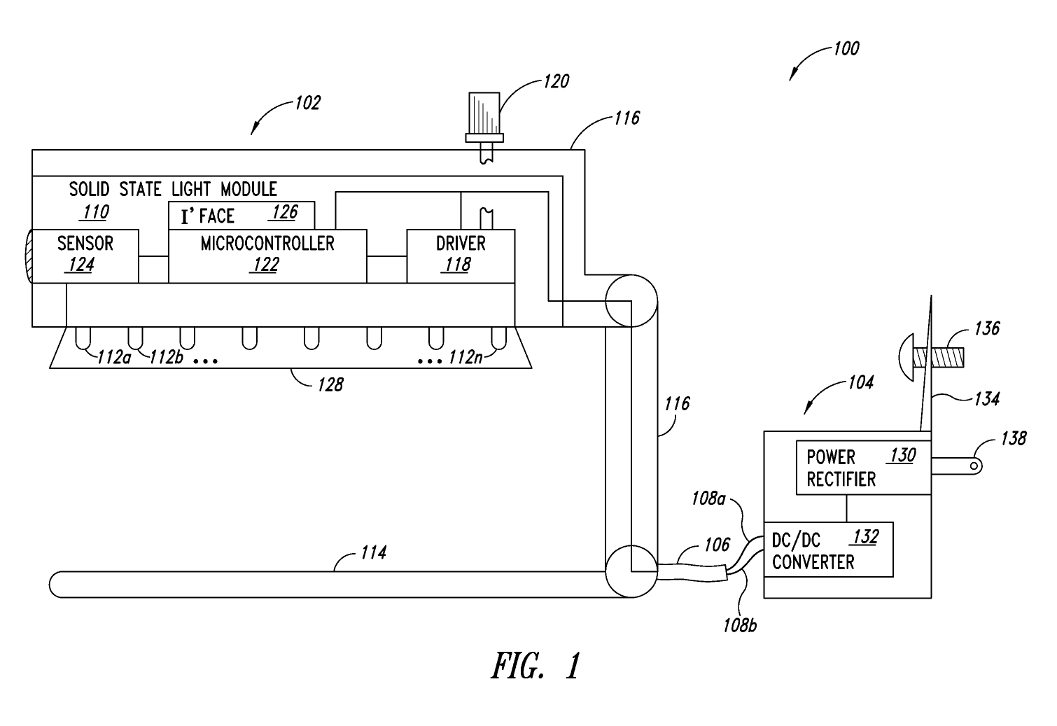

FIG. 1 shows a luminaire 100 according to one non-limiting illustrated embodiment. The luminaire 100 includes a lamp 102 and a power supply 104. The lamp 102 is physically and electrically coupled to a power supply 104 via a cable 106 containing two or more wires 108a, 108b (collectively 108). The lamp 102 includes a solid state light module 110 including any number of solid state light sources 112a-n (collectively 112). The solid state light module 110 is physically coupled to or integrated within the lamp 102 in such a way that any attempt to remove the solid state light module 110 or the solid state light sources 112 will result in permanent damage rendering the solid state light module 110, the solid state light sources 112, and/or the lamp 102 permanently inoperable. Such damage may advantageously provide a theft deterrent in situations such as those encountered in the hospitality industry where lighting fixtures are used in uncontrolled or publicly accessible environments.

The lamp 102 can include any structure suitable for supporting the solid state light module 110 on a surface such as a wall, desktop, floor, or tabletop to mention just a few. In at least some instances, for example where the lamp 102 is intended for use on a table or desk top, the lamp 102 may include a base member 114 that is operably and physically coupled to at least one elongated support member 116, for example an arm, a leg or a pole. In other instances the lamp 102 may include only a base member 114, for example where the lamp 102 is intended for use on a wall (e.g., a sconce). The elongated support member 116 may have at least one dimension that exceeds the dimensions of standard size luggage such as a carry-on bag or similar hand carried or wheeled luggage. In at least some instances, the elongated support member 116 can include a plurality of members that are movably, rotatably, or pivotably coupled to provide an articulated assembly able to position the solid state light module 110 in a variety of physical positions, configurations, or orientations with respect to the surface upon which the lamp 102 is mounted or placed. An example of such an arrangement is an adjustable desk lamp or the like. In other instances, the elongated support member 116 can be affixed to the base member 114 to rigidly position the solid state light module 110 in a fixed location. An example of such an arrangement is a table lamp or the like.

The solid state light module 110 can be of a construction or include one or more features that render the solid state light module 110 permanently inoperable upon removal or attempted removal of the solid state light module 110 from the lamp 102. For example, upon removal or attempted removal of the solid state light module 110 from the lamp 102, one or more breakaway or frangible electrical contacts may separate, permanently eliminating the ability to supply control or operating power to the solid state light module 110. In another instance, the solid state light module 110 may be formed at least partially upon or using a frangible, breakable, fracturable, or structurally brittle substrate that is formed in a manner that fails or is compromised to an extent that renders the solid state light module 110 permanently inoperable upon removal or attempted removal of the solid state light module 110 from the lamp 102.

The solid state light sources 112 can include surface solid state light sources such as surface mount LEDs, through the board mounted solid state light sources such as through the board LEDs, or any combination thereof. In at least some instances the solid state light sources 112 can be physically or electrically attached or coupled to a member such as a printed circuit board. In some instances, at least a portion of the solid state light sources 112 may be at least partially disposed in a reflector or other passive optical device used to point, direct, or otherwise focus the electromagnetic energy emitted by the solid state light sources 112. The solid state light sources 112 can include any number of light emitting diodes (LEDs), organic light emitting diodes (OLEDs), or polymer light emitting diodes (PLEDs). While illustrated as a bulb, the light sources do not necessarily have to be enclosed in a bulb structure. For example, the solid state light sources 112 may take the form of one-, two-, or even three-dimensional arrays of individual LEDs or strings of LEDs.

The solid state light module 110 may include one or more driver circuits 118. In at least some instances, the one or more driver circuits 118 can convert a direct current (“DC”) input voltage supplied by the power supply 104 to a constant current having parameters matched to the type of LEDs used to provide the solid state light sources 112. In some instances the one or more driver circuits 118 may be used to control the luminous output or intensity of the solid state light sources 112. In some instances, the one or more driver circuits 118 can vary the current flowing through all or a portion of the number of solid state light sources 112 to adjust the luminous output or intensity of the solid state light sources 112. In other instances, the one or more driver circuits 118 can generate a constant current output using pulse width modulation (PWM) to adjust or vary the luminous output or intensity of the solid state light sources 112. In at least some instances, an electromechanical rotary dimmer switch 120 to adjust the luminous output or intensity of the solid state light sources 112 can provide an input to the one or more driver circuits 118.

In some instances, the solid state light module 110 may also include a microcontroller 122 useful in controlling or adjusting one or more operational aspects of the solid state light sources 112. In at least some instances, the microcontroller 122 can include and may execute one or more sets of machine executable instructions that cause the microcontroller 122 to perform one or more actions. Such actions can include, but are not limited to controlling the luminous output or intensity of all or a portion of the number of solid state light sources 112 based on an input received from an electronic dimmer input or one or more sensors 124 that are communicably coupled to the microcontroller 122.

In some instances, the microcontroller 122 can provide a control input to at least a portion of the one or more driver circuits 118. Such driver control inputs can enable a power ON or a power OFF to the solid state light sources 112 provide a dimming input to the solid state light sources 112, or combinations thereof. For example, the control input provided by the microcontroller 122 to the one or more driver circuits 118 may be a pulse width modulation (PWM) signal to cause the one or more driver circuits 118 to apply the constant current for a first period of time and not apply the constant current for a second period of time. In at least some instances, a plurality of solid state light sources 112 or strings of solid state light sources 112 may be driven by a single driver 118.

The solid state light module 110 may optionally include one or more sensors 124. The one or more sensors 124 can include one or more motion sensors, one or more proximity sensors, one or more smoke or particulate sensors, one or more oxygen sensors, one or more carbon monoxide sensors, or combinations thereof. The one or more sensors 124 can generate one or more output signals including data indicative of one or more ambient conditions measured or otherwise detected by the sensor 124. The one or more output signals generated by the one or more sensors 124 can be provided to the microcontroller 122. The machine executable instructions executed by the microcontroller 122 can adjust one or more operational aspects of the solid state light sources 112 responsive to one or more conditions measured or otherwise detected by the sensor 124. For example, the microcontroller 122 may reduce the luminous output of the solid state light sources 112 responsive to a failure to detect motion in an area proximate the sensor 124 (i.e., indicating that a person may have left the area without turning off the light). In another example, the microcontroller 122 may cause the luminous output of the solid state light sources 112 to alternate between two levels (i.e., to flash or pulsate) responsive to the detection of high levels of smoke, particulate, or carbon monoxide by the sensor 124.

The solid state light module 110 may optionally include one or more network interfaces 126. Such network interfaces 126 can support the communicable coupling of the microcontroller 122 with an external electronic device using a wired or wireless connection. In some instances, a wired connection with one or more external electronic devices may be formed using high frequency signals imposed on the power distribution grid used to power the solid state light sources 112 and to which the power supply 104 is coupled. In other instances, a wireless connection with one or more external electronic devices may be formed using any available network and network protocol, including but not limited to IEEE 802.11 (WiFi), Bluetooth®, and Near Field Communications (NFC). Such network communications may, for example, be performed using IEEE 802.11 WiFi networks found in many hospitality settings. Once established, messages indicative of an elevated smoke level, an elevated carbon monoxide level, and the like may be transmitted to a remote electronic device, such as a monitoring station maintained at the front desk of a hotel. In another instance, the disappearance of a signal containing data indicative of a particular lamp 102, power supply 104, or solid state light module 110 may trigger an alert indicative of the potential removal of the lamp 102, power supply 104 or solid state light module 110 at a remote electronic device such as a monitoring station

The base member 114 and the elongated support member 116 may include a material of any type or construction able to support the solid state light module 110. In at least some instances all or a portion of the base member 114, elongated support member 116, or combinations thereof, may include a frangible, or brittle material. Such a frangible or brittle material may, for example, be used in an area of the elongated support member 116 that is proximate the solid state light module 110 such that any attempt to remove the solid state light module 110 results in the partial or complete destruction of all or a portion of the elongated support member 116. In some instances, removal or attempted removal of the solid state light module 110 from the lamp 102 can result in physical damage to or the destruction of one or more attachment features necessary to attach the solid state light module 110 to the elongated support member 116, thereby rendering the lamp 102 permanently inoperable. In other instances, removal or attempted removal of the solid state light module 110 from the lamp 102 can result in physical damage to or the destruction of one or more electrical conductors necessary to electrically couple the solid state light module 110 to the power supply 104, thereby rendering the lamp 102 permanently inoperable.

In at least some instances, the physical size, shape, or configuration of the base member 114, the elongated support member 116, or the combination thereof may be sufficient to prevent the insertion of the lamp 102 in a piece of handheld luggage or a suitcase. For example, the base member 114, the elongated support member 116 or the combination thereof may have one or more dimensions exceeding the interior dimensions of portable luggage to reduce the likelihood that the lamp 102 and power supply 104 can be surreptitiously carried from a guest room or public area concealed inside of a piece of luggage.

In at least some instances, the lamp 102 may include a permanently attached lamp shade, diffuser, lens or other optical element 128. In at least some instances, the lamp shade 128 can have a physical size, shape, or configuration to prevent the insertion of the lamp 102 in a piece of handheld luggage or a suitcase. In other instances, the lamp shade 128, the elongated support member 116, or both the lamp shade 128 and the elongated member 116 can be permanently damaged upon removal or attempted removal or detachment of the lamp shade 128 from the elongated support member 116.

The lamp shade 128 may include, in whole or in part, brittle, frangible, or fracturable elements that are permanently damaged in the event an attempt is made to remove the lamp shade 128 from the lamp 102. In some instances, removal or attempted removal of the lamp shade 128 may cause permanent physical damage to the elongated support member 116 to which the lamp shade 128 is attached. In other instances, removal or attempted removal of the lamp shade 128 may cause permanent physical damage to one or more electrical conductors in the lamp, thereby rendering the lamp 102 permanently inoperable.

The power supply 104 can include, but is not limited to, one or more alternating current (AC) to DC converters or rectifiers 130 and a number of DC/DC converters 132 (e.g., a number of DC/DC buck converters), isolation transformers, filters, smoothing capacitors, etc. to rectify, step a voltage and otherwise transform or condition electrical power from an external source into a form suitable to power the components of the solid state light module 110 or solid state light sources 112. In some instances, a number of DC/DC converters 132 may be used to step a voltage down to a first level suitable for the solid state light module 110. In at least some instances, the power supply 104 is physically and electrically coupled to the lamp 102 using one or more cables 106, each of the one or more cables 106 having a plurality of conductors 108 routed therethrough. In at least some instances, the cable 106 conductively coupling the power supply 104 to the lamp 102 may be formed integral with (e.g., without detachable connectors) the lamp 102, power supply 104 or both to prevent the detachment or separation of the power supply 104 from the lamp 102. Preventing the detachment of the power supply 104 from the lamp 102 may advantageously deter theft of the lamp 102, particularly where the power supply 104 is physically attached to an immovable structure.

The power supply 104 can include one or more features such as blades, prongs or the like 138 for coupling to an AC power supply such as a wall outlet. The blades 138 may be directly or indirectly (e.g., through one or more filters) electrically coupled to the power rectifier 130.

One or more security features 134 may be disposed upon or formed integral with the power supply 104. Such security mechanisms 134 may include any number of features, devices, or systems that prevent the decoupling or disconnection of the power supply 104 from a power source (e.g., preventing the removal of a “wall wart” type power supply from an AC wall outlet). In at least some instances, the one or more security features 134 may be used to physically attach the power supply 104 to an immovable object such as a wall. In at least some instances, the one or more security features 134 may be used to physically attach and electrically couple the power supply 104 to a source of power such as an AC power outlet. In at least some instances, a tang or projection from an exterior surface of the power supply 104 may include an aperture to accommodate the passage of one or more fasteners therethrough. In at least some instances, the one or more fasteners can be used to join the power supply 104 to a wall outlet or other source of power for the power supply 104. The one or more fasteners used to attach the power supply 104 to the source of power can include, in some instances, a machine screw having a unique or tamper proof head design that requires the use of a specialized or limited access tool (e.g., a Torx, Security Torx, Pentalobe, etc.) to remove the one or more fasteners.

All or a portion of the one or more security features 134 may be integrally formed with the power supply 104. For example, the power supply 104 may be physically configured and sized for mounting within a junction box or similar protective enclosure. The junction box or enclosure may include screw type terminals and/or circular openings that are sized to receive standard gauge wire with spring-loaded contacts permitting the electrical coupling of the power supply 104 to the lamp 102 and to the source of power. The power supply 104 can include one or more lugs or similar mounting features permitting the secure attachment of the power supply 104 within the junction box or enclosure. In such instances, the power supply 104 can be undetachably physically attached to the lamp 102 via the cable 106 and electrically coupled to the lamp 102 via the wires 108. Such construction renders the lamp 102 detachable only by cutting the cable 106 and wires 108, which removes the power supply 104 and renders the lamp permanently inoperable.

By incorporating one or more of the aforementioned protections, the unauthorized removal of the luminaire 100 is deterred by: rendering the solid state light module 110 or the solid state light sources 112 permanently inoperable if removed from the lamp 102; attaching the power supply 104 to the lamp 102 without the use of connectors to prevent the disconnection of the power supply 104 from the lamp 102; attaching the power supply to the electrical source using one or more security mechanisms 134; and physically configuring the lamp fixture 102 or the shade 128 to reduce the likelihood of the lamp 102 fitting within conventional, hand-carried, luggage. Such protections advantageously permit the use of relatively high cost, energy efficient, light fixtures using solid state light sources in uncontrolled (e.g., guest rooms) and public areas (e.g., stairways, hallways, etc.) in the hospitality industry.

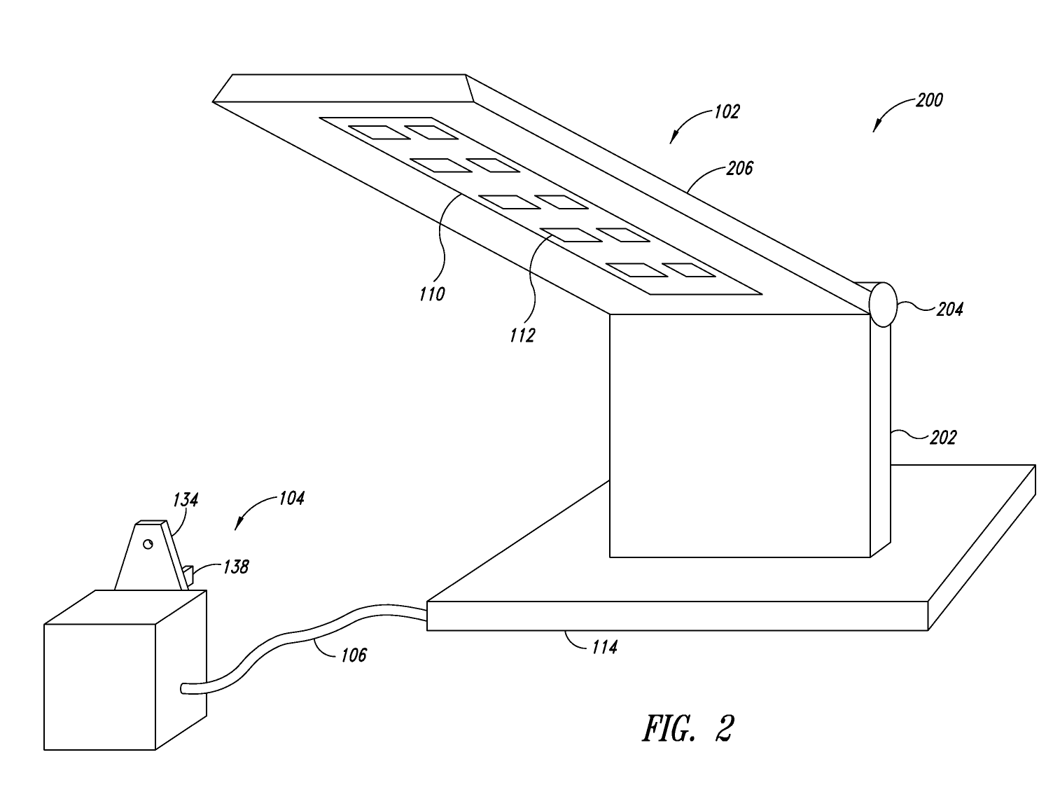

FIG. 2 shows an example luminaire 200 useful in the hospitality industry. The luminaire 200 includes a lamp formed by an elongated support member 116 including two members 202, 206 that are physically and operably joined using at least one hinged connection 204. A solid state light module 110 is disposed within the member 206 that pivots about the one or more hinged connections 204. Although shown in FIG. 2 as two hingedly coupled planar, rectangular members, the elongated support member 116 can include any number, size, or shape members. Additionally, although the members 202 and 206 forming the elongated support member 116 are shown in FIG. 2 as hingedly coupled using a single hinged connection 204, any type, number, or combination of rotatable, pivotable, telescoping, or articulable joints may be similarly used to physically and operably couple any number of members forming the elongated support member 116. For example, a luminaire 200 may contain a hinged connection oriented along a first axis and rotatable connection oriented about a second axis.

The solid state light module 110 is disposed within the member 206 using one or more physical attachments and one or more electrical conductors such that any removal or attempted removal of the solid state light module 110 from the member 206 results in physical and/or electrical damage to the solid state light module 110, the solid state light sources 112, the member 206, or any combination thereof. Such damage renders the luminaire 200 or the solid state light module 110 permanently inoperable.

The power supply 104 is physically attached and electrically coupled to the lamp 102 via the one or more cables 106. In at least some instances, one or more cut resistant elements may be routed through the cable 106. In some instances a cut resistant material may be routed through the cable 106 in parallel with the one or more wires 108. In other instances, a cut resistant sheath (e.g., a Kevlar® or similar sheath) may be partially or completely formed about or surround all or a portion of the cable 106.

In some instances, the cable 106, the wires 108 or both may be secured in housings that cannot be opened or otherwise accessed without compromising the integrity of the housing and rendering the luminaire 200 permanently inoperable. For example, the ends of the cable 106, the wires 108 or both may be secured internally within the base 114 of the luminaire 200 and the base of the power supply 104. Any attempt to access the interior of the base 114 or the power supply 104 can result in physical or electrical damage rendering the luminaire 200 permanently inoperable.

The power supply is equipped with a security mechanism 134 that enables the physical attachment of the power supply 104 to a wall outlet or similar source of power. The security mechanism 134 may use a “one-way” fastener (i.e., a fastener that can be inserted but not removed); a fastener requiring a special tool that is not commercially available (e.g. a screw having a special or proprietary head configuration); or a locking mechanism requiring a key assembly for removal. The security mechanism 134 may include any number or combination of features to resist or prevent the removal or detachment of the power supply 104 from a wall outlet or similar source of power. In at least some instances, the security mechanism 134 may be secured or attached to the wall outlet using one or more threaded fasteners having a non-standard or unique head design such that the threaded fastener can only be removed using one or more specialty tools.

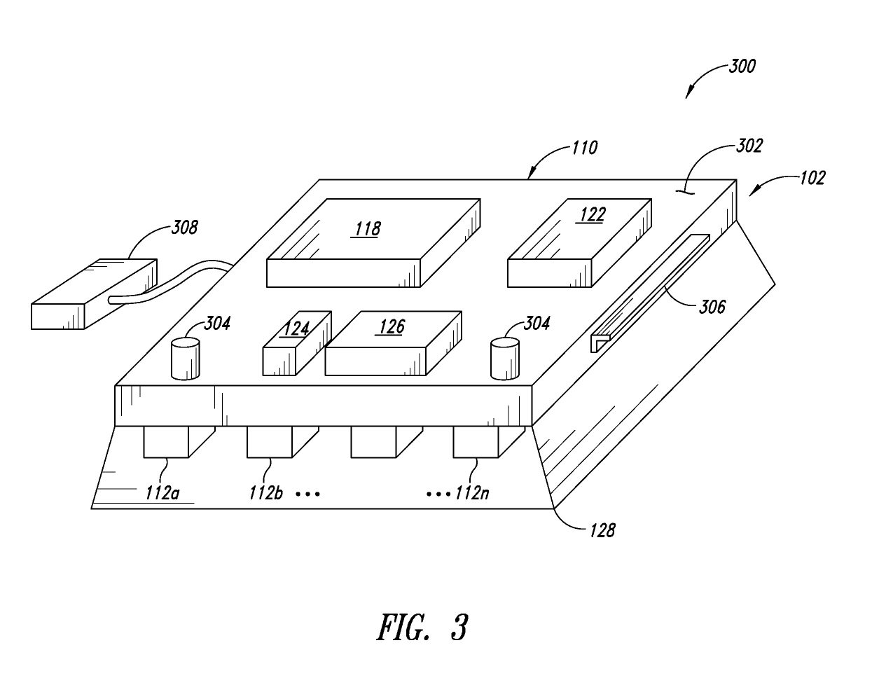

FIG. 3 shows a perspective view of a solid state light module 110 for physical attachment and electrical coupling to a luminaire 200 such as that shown in FIG. 2. In at least some instances, the solid state light module 110 shown in FIG. 3 may be used in a luminaire 200 from which a failed solid state light module 110 has been removed. While removal of the failed solid state light module 110 may render the module permanently inoperable, the luminaire 200 may be configured such that removal of the failed solid state light module 110 causes no physical damage to the luminaire 200. Thus, while offering the theft deterrent benefits described above (e.g., attempted removal of the solid state light module 110 results in damage rendering either or both the solid state light module 110 and the solid state light sources 112 inoperable) such a “destructive replacement” arrangement offers the benefit of being able to replace a failed solid state light module 110 without incurring the cost to replace the entire luminaire 200. Although the components forming the solid state light module 110 are displayed as exposed in FIG. 3, in some instances a cover (e.g., a plastic or polymeric covering) or sealing layer (e.g., a thermoformed or thermoset coating) may be disposed across all or a portion of the components.

In at least some instances, the solid state light module 110 can include one or more driver circuits 118 and may optionally include one or more microcontrollers 122, one or more sensors 124, and one or more network interfaces 126 as previously described in detail with regard to FIG. 1. Each of the components is mounted on a substrate member 302 that may include a printed circuit board or similar system or device electrically and communicably coupling the various components attached thereto. In some instances, all or a portion of the substrate member 302 can include a frangible, breakable, fracturable, or brittle material permitting the insertion of the solid state light module 110 into a light fixture without damaging the solid state light module 110 or the solid state light sources 112 and resisting the removal of the light module 110 from the light fixture.

In some instances, one or more frangible or fracturable conductors or traces may be formed internal to or on one or more surfaces of the substrate 302. In such instances, flexure of the substrate 302 can cause the conductors to fracture electrically disrupting the solid state light module 110 and rendering the solid state light module permanently inoperable. In other instances a layer including an adhesive may be applied to one or more surfaces of the substrate 302 containing electrical conductors or traces. Any attempt at removing the solid state light module 110 can cause the layer to separate from the substrate 302. As the layer separates from the substrate 302, the adhesive in the layer can pull all or a portion of the electrical conductors or traces to which the layer has been applied from the substrate 302 thereby rendering the solid state light module 110 permanently inoperable.

The solid state light module 110 can include one or more fasteners 304 physically coupled to the substrate member 302. The fasteners 304 can include one or more features (e.g., physical tabs, nubs, threads, ridges, or similar surface features) that permit the attachment or insertion of the solid state light module 110 into the light fixture and resist the detachment or removal of the solid state light module 110 from the light fixture. For example, the one or more fasteners 304 may be attached to the substrate member 302 with a frangible or brittle material that physically and electrically fractures the substrate member 302 proximate the one or more fasteners 304 upon attempted removal of the solid state light module 110. Such a construction would facilitate the destructive removal of a failed solid state light module 110 from a light fixture (i.e., physical damage to a failed solid state light module 110 is acceptable) thereby permitting the salvage of the light fixture by inserting the replacement solid state light module 110 shown in FIG. 3. In some instances, the one or more fasteners 304 may include one or more “one-way” fasteners (i.e., a fastener that can be inserted but not removed); one or more fasteners requiring a special tool that is not commercially available (e.g. a screw having a special or proprietary head configuration such as Torx, Security Torx, or Pentalobe); or one or more locking mechanisms requiring a key assembly for removal. In some instances, the one or more fasteners may include a chemical adhesive or similar agent capable of physically or chemically bonding the solid state light module 110 to the light fixture.

The solid state light module 110 may also include one or more surface features 306 disposed on or about the solid state light module 110 to retain the solid state light module 110 in the light fixture. Such surface features 306 may include ridges or similar surface features such as protrusions or detents that are attached to or formed with at least a portion of the substrate member 302.

The solid state light module 110 optionally includes one or more electrical connectors 308 to electrically and communicably couple the solid state light module to a host light fixture. Such connectors can take any form including screw or snap type connectors. In at least some instances, the one or more electrical connectors 308 may incorporate one or more features that result in the physical or electrical destruction of the electrical connector 308 upon detachment of the connector from the host light fixture. In at least some instances, electrical power from the power converter 104 to the solid state light module 110 is provided across the electrical interface within the one or more electrical connectors 308. In other instances, one or more control signals, for example a signal from a mechanical, electromechanical, or electrical dimmer, is provided across the electrical interface within the one or more electrical connectors 308.

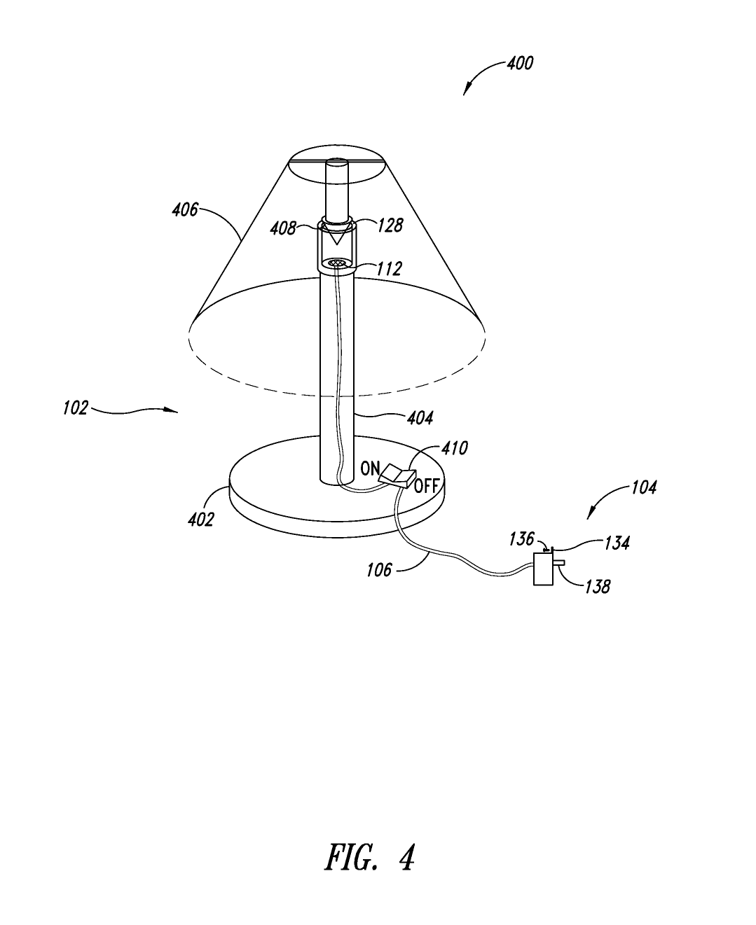

FIG. 4 shows another example luminaire 400 in the form of a table lamp that is particularly useful in the hospitality industry. The luminaire 400 includes a lamp formed by a base member 402 and a perpendicularly or near-perpendicularly arranged elongated support member 404. A non-detachable shade 406 is physically coupled to the elongated support member 404. One or more solid state light sources 112 are disposed opposite one or more reflective elements 408 positioned to reflect incident light from the one or more solid state light sources 112 in a preferred distribution pattern about the luminaire 400. All or a portion of the solid state light sources 112 and the one or more reflective elements are disposed within a lens or optical element 128. Power flow from the power supply 104 to the one or more solid state light sources 112 is controlled using an ON/OFF switch 410 that electrically conductively couples the one or more solid state light sources 112 with the power supply 104. The ON/OFF switch can be positioned along the cable 106 or on the lamp 102, for example on the base 402 or elongated support member 404.

The elongated support member 404 can have any shape, size, or configuration capable of supporting at least the one or more solid state light sources 112 and the non-detachable shade. In at least some instances, the elongated support member 404 can be a thermally conductive, at least partially hollow, rigid member having an interior space through which a plurality of wires 108 electrically coupling the one or more solid state light sources 112 to the ON/OFF switch 410 are routed. In at least some instances, the one or more solid state light sources 112 may be thermally conductively coupled to the elongated support member 404. In such instances, at least a portion of the thermal energy or heat generated by the one or more solid state light sources 112 during operation may be transmitted or otherwise transferred to the elongated support member 404. After receiving the thermal energy or heat generated by the solid state light source 112 the elongated support member 404 may serve as a thermal radiator or heat sink to transport heat away from the one or more solid state light sources 112.

The lens or optical element 128 can be an optically transparent, translucent, or opaque member partially or completely surrounding or enclosing the one or more solid state light sources 112. In at least some instances, one or more substances may be formed within the lens or optical element 128 or one or more coatings may be applied to the interior or exterior surfaces of the lens or optical element 128 to alter or adjust the spectral content of the visible light provided by the lamp 400. For example, in some instances, the lens or optical element 128 may include an integral substance or an applied coating that limits the passage of cooler blue wavelengths of visible light while permitting or otherwise facilitating the passage of warmer yellow wavelengths of visible light. The lens or optical element 128 can be permanently, non-detachably affixed or attached to the elongated support member 404.

In at least some instances, one or more reflective elements 408 may be disposed at least partially within the lens or optical element 128. Such reflective elements may have any shape or size such as conical, frustoconical, pyramidal, and the like. In at least some instances, the one or more light sources 112 can be a generally planar solid state light source that emits visible light in an upward direction toward the one or more reflective elements 408. Upon falling incident upon the one or more reflective elements 408, the visible light can be evenly or unevenly distributed or otherwise radiated in one or more preferred outward directions through the lens or optical element 128. The use of the one or more reflective elements 408 therefore advantageously limits the amount of visible light emitted by the one or more light sources 112 that is able to escape upward from the lamp by redirecting the visible light in one or more preferred directions (e.g., radially outward or downward).

The power supply 104 and base member 402 are physically attached and electrically coupled by the cable 106. The wires 108 in the cable 106 (not shown in FIG. 4) are electrically conductively coupled to the power supply 104 and the ON/OFF switch 410. The ON/OFF switch 410 can include any system, device, or combination of systems and devices to control the flow of power from the power supply 104 to the number of solid state light sources 112. In some instances, the ON/OFF switch 410 may have one or more features, characteristics, or properties (e.g., increased size, contrasting color, etc.) to facilitate operation of the ON/OFF switch 410 by the elderly or mobility impaired.

In at least some instances, the luminaire 400 can include a shade or diffuser 406 that is permanently affixed to at least a portion of the elongated support member 404. The shade or diffuser 406 can be a transparent, translucent or opaque member that permits the passage of all, a portion, or none of the light emitted by the one or more light sources 112 and reflected by the one or more optical reflectors 408. Removal or attempted removal of the shade or diffuser from the luminaire 400 will result in damage to or the destruction of the elongated support member 404, the lens or optical element 128, all or a portion of the light sources 112, or other components to an extent that renders either or both the luminaire 400 and the one or more light sources 112 permanently inoperable. In at least some instances, the shade or diffuser 406 may have a physical size, shape, or configuration that hinders or makes impossible the carriage of the luminaire 400 in a standard piece of luggage.

As used herein and in the claims, adjusting an illumination level of a solid state light source includes turning ON a light source from an OFF state in which no light or illumination is produced to an ON state at which at least some light or illumination is produced. As used herein and in the claims, adjusting an illumination level includes turning OFF a light source from an ON state in which at least some light or illumination is produced to an OFF state at which no light or illumination is produced.

As used herein and in the claims, adjusting an illumination level also includes increasing and/or decreasing a level of light or illumination produced. Such may include adjusting an output level for any given discrete light source. Such may additionally or alternatively include adjusting a total number of light sources that are in the ON state. For example, a first and second set or strings of light sources may be used to produce a first level of light or illumination, while only the first set or string of light sources may be used to produce a second level of light or illumination. Also for example, a first number of light sources in a first set or string may be used to produce the first level of light or illumination, while a smaller number or subset of light sources in the first set or string may be used to produce the second level of light or illumination.

When logic is implemented as software and stored in memory, logic or information can be stored on any computer-readable medium for use by or in connection with any processor-related system or method. In the context of this disclosure, a memory is a computer-readable storage medium that is an electronic, magnetic, optical, or other physical device or means that non-transitorily contains or stores a computer and/or processor program. Logic and/or information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any element that can store the program associated with logic and/or information for use by or in connection with the instruction execution system, apparatus, and/or device. The computer-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), and digital tape.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

We claim:

1. A solid state light fixture, comprising:
a stand that has a base and at least one elongated support member physically coupled to the base;
a light module that includes a number of solid state light sources, the light module physically permanently attached to the at least one support member such that an attempted removal of the light module renders at least one of the light module or the solid state light sources permanently inoperable; and
an external power supply pluggable to an alternating current electrical power outlet, the external power supply electrically conductively coupled to the light module that includes the solid state light sources to provide direct current electrical power thereto via at least one cable with at least two wires, the external power supply non-removably physically coupled to at least a portion of the stand via the at least one cable.

2. The solid state light fixture of claim 1 wherein the external power supply includes at least one security mechanism that in use securely attaches the external power supply to alternating current electrical power outlet.

3. The solid state light fixture of claim 2 wherein the external power supply includes at least two prongs receivable by respective ones of at least two slots of the alternating current electrical power outlet, and the security mechanism includes a ring having an opening sized to receive a threaded security fastener therethrough, the ring positioned relative to the prongs to align a center of the opening with a center tap hole of the alternating current electrical power outlet when the prongs are received by the respective slots of the alternating current electrical power outlet.

4. The solid state light fixture of claim 1, further comprising:
a diffuser attached to the stand.

5. The solid state light fixture of claim 1, further comprising:
a diffuser permanently attached to the stand.

6. The solid state light fixture of claim 1, further comprising a dimmer control to manually adjust the luminous output of the number of solid state light sources.

7. The solid state light fixture of claim 6, wherein the dimmer control includes a manual dimmer.

8. The solid state light fixture of claim 1, further comprising a motion sensor communicably coupled to the lamp control subsystem, the motion sensor to provide a motion signal to the microcontroller when movement is detected in an area about the solid state light fixture.

9. The solid state light fixture of claim 1, wherein at least a portion of the stand includes a thermally conductive material thermally conductively coupled to at least a portion of the number of solid state light sources.

10. The solid state light fixture of claim 9, wherein at least a portion of the elongated support member includes a thermally conductive material.

11. A solid state light module, comprising:
a number of solid state light sources physically coupled to a structure;
at least one physical coupler to operably connect the structure to a support member, the at least one physical coupler including one or more features that when physically coupled to the support member, render at least one of the solid state light module or the solid state light sources permanently inoperable upon attempted removal of the structure from the support member; and
at least one electrical coupler to conductively connect the solid state light module to a power source via at least one cable with at least two wires, the electrical coupler including one or more features that, once engaged to the power source, render at least one of the solid state light module or the solid state light sources permanently inoperable upon attempted removal of the structure from the support member.

12. The solid state light module of claim 11, further comprising at least one power controller conductively coupled to the number of solid state light sources and conductively coupled to the electrical coupler to adjust the luminous output of at least a portion of the number of solid state light sources.

13. The solid state light module of claim 12, further comprising a manual dimmer switch operably coupled to the at least one power controller.

14. The solid state light module of claim 12, further comprising a microcontroller conductively coupled to the power controller, the microcontroller having at least one input and at least one output, the at least one output communicably coupled to the at least one power controller.

15. The solid state light module of claim 14, further comprising at least one intensity controller communicably coupled to the at least one microcontroller input.

16. The solid state light module of claim 14, further comprising at least one of a motion detector or a proximity detector communicably coupled to the at least one microcontroller input.

17. The solid state light module of claim 11, further comprising a diffuser physically coupled to the solid state light module.
